(19) United States
(12) Patent Application Publication
(10) Pub. No.: US 2003/0186091 A1
(43) Pub. Date: Oct. 2, 2003

(54) Power paint composition

(76) Inventors: Rudolfus Antonius Theodorus Maria Van Benthem, Limbricht (NL); Pieter Gijsman, Groot Genhout (NL); Willem Grisnich, Zwartsluis (NL)

Correspondence Address: PILLSBURY WINTHROP, LLP, P.O. BOX 10500, MCLEAN, VA, 22102, US

(21) Appl. No.: 10/221,390

(22) PCT Filed: Feb. 19, 2001
(86) PCT No.: PCT/NL01/00141

(30) Foreign Application Priority Data
Mar. 13, 2000 (EP) 00200876.1

(51) Int. Cl. B32B 9/04

(52) U.S. Cl. 428/704

(57) ABSTRACT

The invention relates to a powder paint binder composition containing a compound comprising carboxylic acid units, a compound comprising hydroxyalkyl amide units one or more phosphite(s) optionally combined with one or more phenolic anti-oxidant(s) and either:

a) one or more aromatic amine(s) or

b) one or more phosphinic acid(s) according to formula I or II:

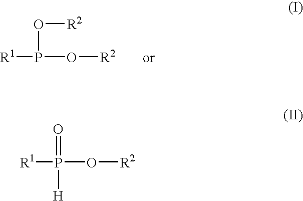

where

R¹=H, (C₁-C₂₆) alkyl or (C₆-C₂₀) aryl

R²=H, (C₁-C₂₆) alkyl or (C₆-C₂₀) aryl and

R³=H, (C₁-C₂₆) alkyl or (C₆-C₂₀) aryl.

The invention relates to a powder paint composition containing a compound comprising carboxylic acid units and a compound comprising hydroxyalkyl amide units. The invention also relates to the powder coating obtained after curing of the powder paint composition.

WO 99/16810 discloses a powder paint composition comprising a condensation polymer containing ester groups, at least one amide group in the backbone and having at least one hydroxyalkylamide endgroup. The heat stability after curing in an electric oven has to be improved.

The object of the invention is to provide a powder paint composition resulting in an improved combination of the characteristics colour and heat stability.

The powder paint composition according to the invention contains a compound comprising carboxylic acid units, a compound comprising hydroxyalkyl amide units and

i. one or more phosphite(s)

ii. and either:

a) one or more aromatic amine(s) or

b) one or more phosphinic acid(s) according to formula I or II:

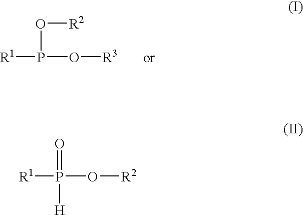

where

R¹=H, (C₁-C₂₆) alkyl or (C₆-C₂₀) aryl

R²=H, (C₁-C₂₆) alkyl or (C₆-C₂₀) aryl and

R³=H, (C₁-C₂₆) alkyl or (C₆-C₂₀) aryl

iii. optionally combined with one or more phenolic anti-oxidant(s).

The powder paint composition according to the invention results after curing in a powder coating having a good combination of colour and heat stability properties. Furthermore other desirable properties, for example impact resistance, chemical resistance and flow, are obtained.

Suitable phosphites include for example monophosphites, diphosphites and polyphosphites.

Suitable monophosphites include for example trisnonylphenyl phosphite, trilauryl phosphite, tris (2,4-di-t-butylphenyl) phosphite, di-isooctylphosphite, triisodecyl phosphite, diisodecylphenylphosphite, diphenyl isodecyl phosphite, triphenyl phosphite, tris(tridecyl)phosphite, diphenyl isooctyl phosphite, 12H-dibenzo [d,g][1,3,2] dioxaphosphocin, 2,4,8,10-tetrakis(1,1-dimethylethyl)-6-(octyloxy)-2,2′-ethylidenebis (4,6-di-t-butylphenyl) fluorophosphonite, di-sodium-hydrogen-phosphite, phosphorous acid, bis[2,4-bis(1,1-dimethylethyl)-6-methylphenyl]ethyl ester, 2,4,6 tri-t-butylphenyl-2-butyl-2-ethyl-1,3-propane-diol-phosphite, triisooctyl phosphite, tris (dipropyleneglycol) phosphite, diisooctyl octylphenyl phosphite, tris-(2,4-di-tert.butyl-5-methylphenyl)-phosphite, diphenylphosphite, phenylneopentyleneglycolphosphite, phosphorous acid and trioctadecyl ester. Preferably tris (2,4,-di-tert-butylphenyl) phosphite is used.

Suitable diphosphites include for example 2,4,8,10-tetraoxa-3,9-diphosphaspiro[5.5] undecane, 3,9-bis(octadecyloxy)-3,9-, tetrakis-(2,4-di-tert-butyl-phenyl)-4,4′-bi-phenylene-di-phosphonite, bis(2,4-di-t-butylphenyl)-pentaerythritol-diphosphite, bis-(2,6-di-tbutyl-4-methyl-phenyl)-pentaerythritol-di-phosphite, bis-(2,4,6-tri-tbutyl-phenyl)-pentaerythritol-di-phosphite, poly-4,4′-isopropylidene-diphenol-C₁₂₋₁₅ alcohol-phosphite, tetrakis-isodecyl 4,4′-isopropylidene-diphosphite, bis-(2,4-dicumylphenyl)-pentaerythritol-diphosphite, phosphorous acid, (1-methylethylidene)di-4,1-phenylene-tetraoctadecyl ester, phosphorous acid, oxybis (methyl-2,1 ethane diyl) tetraphenyl ester, 2,4,8,10-tetraoxa-3,9-diphosphaspiro[5.5]undecane,3,9-bis(nonylphenoxy)-pentaerythritol-diphosphite, and diisodecyl-pentaerythritol-diphosphite.

Suitable polyphosphites include for example poly(dipropyleneglycol) phenylphosphite, 2,2′,2″-nitrilo-triethyl-tris[3,3′,5,5′-tetratert-butyl-1,1′-biphenyl-2,2′-diyl]phosphite and 3,6,8,11,14,16,19,22,24,27-decaoxa-7,15,23-triphosphanonacosane-1,29-diol.

Suitable aromatic amines include for example 4,4-di-cumyl-diphenyl-amine, N,N-diphenyl-p-phenylenediamine, 2,2,4,-trimethyl-1,2-dihydroquinone polymer, 4,4-dioctyl-diphenylamine, 1,4-benzene diamine, the reaction product of diphenyl amine and acetone, p-isopropylamino diphenylamine, N-1,3-dimethyl-butyl-N-phenyl-paraphenylene-diamine, N,N-di-(1,4 dimethyl-pentyl)-paraphenylene-diamine, mixture of styrenated diphenylamines, 2-naphtheneamine, 1,4-benzenediamine, phenyl-naphthylamine, benzeneamine, octylated diphenyl amine, styrenated diphenylamine and/or p-(p-toluene-sulfonylamido)-diphenylamine.

Preferably the amine is 4,4-di-cumyl-diphenylamine.

The powder paint composition according to the invention can as the other option comprise, in addition to a compound comprising carboxylic acid units a compound comprising hydroxyalkyl amide units and one or more phosphites, one or more phosphinic acid(s) and optionally one or more phenolic anti-oxidants.

Suitable phosphites are as described above.

Suitable phosphinic acid(s) are as represented by formula I or II as shown above. Preferably phosphinic acid (H₃PO₂), (C₁-C₂₆) alkylphosphinic acid or (C₆-C₂₀) arylphosphinic acid is used. More preferred is phosphinic acid, phenylphosphinic acid or 1,8-naphthalene diylphosphinic ester acid. Most preferred is phenylphosphinic acid.

Usually curing takes place in an electrical oven, gasoven or by IR-radiation. Depending on the way the powder paint composition will be cured, it can be very advantageous to use, in addition to the phosphite(s) and either the aromatic amine or the phosphinic acid(s) one or more phenolic anti-oxidant(s). When curing is effected in an electrical oven it is strongly preferred to use at least one phenolic anti-oxidant. In case curing takes place in an electrical oven, the resultant colour of the powder coating is better (synergetic effect) when the anti-oxidant is present. Also other properties are influenced in a positive way by the presence of the phenolic anti-oxidant. In case curing takes place in a gasoven it is preferred not to use an aromatic amine nor a phenolic anti-oxidant. Preferably curing takes place in an electrical oven or by IR.

Suitable phenolic anti-oxidants are well-known to the man skilled in the art. Preferably use is made of: 2,6-t-butyl-4-methylphenol, 2,6-di-t-butyl-4-ethyl-phenol, benzenepropanoic acid, 3,5-bis(1,1-dimethylethyl)-4-hydroxy-octadecyl ester (Irganox 1076), 2,2′-methylenebis (6-t-butyl-4-methylphenol) (Cyanox 2246), 2,2′-methylenebis 6-(1-methylcyclohexyl)-p-cresol (Lowinox WSP), 4,4′-butylidenebis (6-t-butyl-3-methyl-phenol) (Santhowite powder) bis-(2-t-butyl-4-methyl-6-(3-t-butyl-5-methyl-2-hydroxy-benzyl)-phenyl)-terephtalate, 1,1,3-tris (2-methyl-4-hydroxy-5-t-butyl phenyl) butane (Topanol CA), 1,3,5-trimethyl-2,4,6-tris (3,5-di-t-butyl-4-hydroxybenzyl) benzene (Irganox 1330), butyric acid, 3,3-bis(3-t-butyl-4-hydroxyphenyl) ethylene ester (Hostanox O3), 1,3,5-tris(3′,5′-di-t-butyl-4′-hydroxybenzyl)-s-triazine-2,4,6-(1H,3H,5H)trione (Irganox 3114), 1,3,5-tris (4-t-butyl-2,6-dimethyl-3-hydroxy-bezyl)-iso-cyanurate (Cyanox 1790), 3-(3,5-di-t-butyl-4-hydroxy-phenyl) proion acid ester with 1,3,5-tris (2-hydroxy-ethyl)-iso-cyanurate (Goodrite 3125), tetrakis [methylene (3,5-di-t-butyl-4-hydroxyhydrocinnamate)] methane (Irganox 1010), N,N′-hexamethylene bis (3,5-di-t-butyl-4-hydroxyhydrocinnamamide (Irganox 1098), 3,9-bis(1,1-dimethyl-2-(β-(3-t-butyl-4-hydroxy-5-methyl-phenyl)-propyonyl-oxy)-ethyl)-2,4,8,10-tetraoxospiro (Sumilizer GA80), 2,2′-ethylidenebis (4,6-di-t-butylphenol) (Isonox 129), 4,4′-methylenebis (2,6-di-t-butylphenol) (Ethanox 702), tri-ethylene-glycol-bis-3-(t-butyl-4-hydroxy-5-methyl-phenyl)-propionate (Irganox 245), 1,6-hexane-diol-bis-3-(3,5-di-t-butyl-4-hydroxyphenyl)-propionate (Irganox 259), butylated hydroxyanisole (Teenox BHA), 2,6-di-t-butyl-4-sec-butyl-phenol (Isonox 132), 2-propyleneacid, 2-isopentane6[(3-isopentane-2-hydroxy-5-isopentane-phenyl)-ethyl]-4-methyl-phenyl-ester(Sumilizer GS), 2-propylene-acid,2-t-butyl-6-[(3-t-butyl-2-hydroxy-5-methyl-phenyl)-methyl]-4-methyl-phenyl-ester (Sumilizer GM), p-cresol/dicyclopentadiene butylated reaction product (Ralox LC), di-ethyl-ester of 3,5-di-t-butyl-4-hydroxy-benzyl-phosphoric acid (Irganox 1222), 2,5,7,8-tetra-methyl-2-(4′,8′,12′-tri-methyl-tri-decyl)-6-chromanol (Ronotec 201), N,N′-1,3-propanediylbis(3,5-di-t-butyl-4-hydroxyhydrocinnamamide, calcium bis[monoethyl(3,5-di-t-butyl-4-hydroxybenzyl)phosphonate (Irganox 1425). More preferred is 1,3,5-tris(4-tert-butyl-2,6-di-methyl-3-hydroxy-benzyl)-iso-cyanurate, also known as Cyanox™ 1790 (Cytec).

A preferred combination of the phosphite(s), phenolic anti-oxidant(s) and the phosphinic acid(s) is: tris(2,4-di-t-butylphenyl)phosphite (Irgafos™ 168), 1,3,5-tris-(4-tert-butyl-2,6-di-methyl-3-hydroxy-benzyl)-iso-cyanurate (Cyanox™ 1790) and phenylphosphinic acid.

The aromatic amine may be present in a concentration, relative to the weight of the compound comprising carboxylic acid units, of 0,05-5 w %. Preferably in a concentration of 0,5-3 w %, most preferred 0,8-1,8 w %.

The phosphite may be present in a concentration, relative to the weight of the compound comprising carboxylic acid units, of 0,05-10 w %, preferably 0,2-5 w %. Most preferred is a concentration of 0,5-2 w %.

The phenolic anti-oxidant may be present in a concentration, relative to the weight of the compound comprising carboxylic acid-units, of 0-5 w %. Preferably 0,5-2,5 w %, most preferred 0,8-1,5 w %.

The molar ratio between the posphite and the phenolic anti-oxidant (when present) is not critical and can be chosen between wide ranges, for example 20:1 until 1:20. Preferably the ratio is chosen between 10:1 and 1:10. Most preferred is between 10:1 and 6:1.

The molar ratio between the phenolic anti-oxidant (when present) and the phosphinic acid is not critical and can be chosen between wide ranges, for example 25:1 until 1:25. Preferably this ratio is chosen between 10:1 until 1:20, more preferred between 1:1 and 1:18, most preferably between 1:5 and 1:15.

The molar ratio between the phosphite(s) and the phosphinic acid can be chosen between wide ranges, for example 10:1 until 1:10. Preferably between 5:1 and 1:5, more preferred is between 1:1 and 1:2, most preferred between 1:1,2 and 1:1,6.

The aromatic amine together with the phosphite and optionally the phenolic anti-oxidant(s) or the phosphite(s), together with the phosphinic acid(s) and optionally the phenolic anti-oxidant(s) may be added to the polymer, to the binder composition consisting of the polymer and the crosslinker and/or to the powder paint composition.

According to a preferred embodiment of the invention the amine together with the phosphite and optionally the phenolic anti-oxidant(s) or the phosphite together with the phosphinic and acid and optionally the phenolic anti-oxidant are added to the polymer.

The thermosetting powder paint binder composition may contain more than 50% by weight of the compound comprising carboxylic acid units being preferably a polymer and less than 50% by weight of the hydroxylalkylamide groups containing crosslinker.

The polymer is preferably a polymer containing carboxyl groups or containing anhydride groups. Suitable polymers include for example a polyester, a polyacrylate, a polyether (for example a polyether based on bisphenol or a phenol-aldehyde novolak), a polyurethane, a polycarbonate, a trifluoroethylene copolymer or a pentafluoropropylene copolymer, a polybutadiene, a polystyrene or a styrene maleic anhydride copolymer.

Preferably the polymer is a polyester.

Polyesters are generally based on the residues of aliphatic polyalcohols and polycarboxylic acids.

The polyester may comprise units of for example isophtalic acid, terephthalic acid, 2,6-naphthalene dicarboxylic acid and 4,4′-oxybisbenzoic acid.

Other suitable aromatic, cycloaliphatic and/or acyclic polycarboxylic acids useful herein include, for example, 3,6-dichloro phthalic acid, tetrachloro phthalic acid, tetrahydro phthalic acid, hexahydro terephthalic acid, hexachloro endomethylene tetrahydro phthalic acid, phthalic acid, azelaic acid, sebacic acid, decane dicarboxylic acid, adipic acid, succinic acid and maleic acid. These other carboxylic acids can be used in amounts of up to for example 25 mol % of the total amount of carboxylic acids. These acids may be used as such, or, in so far as available as their anhydrides, acid chlorides or lower alkyl esters. Small amounts of trifunctional acids for example trimelittic acid may be applied to obtain branched polyesters.

Hydroxy carboxylic acids and/or optionally lactones can also be used, for example, 12-hydroxy stearic acid, hydroxy pivalic acid and ε-caprolactone. Monocarboxylic acids may, if desired, be used in minor amounts. Examples of these acids are benzoic acid, tert.-butyl benzoic acid, hexahydro benzoic acid and saturated aliphatic monocarboxylic acids.

Useful polyalcohols, in particular diols, reactable with the carboxylic acids to obtain the polyester include aliphatic diols. Examples are ethylene glycol, propane-1,2-diol, propane-1,3-diol, butane-1,2-diol, butane-1,4-diol, butane-1,3-diol, 2,2-dimethylpropanediol-1,3 (=neopentyl glycol), hexane-2,5-diol, hexane-1,6-diol, 2,2-bis-(4hydroxy-cyclohexyl)-propane (hydrogenated bisphenol-A), 1,4-dimethylolcyclohexane, diethylene glycol, dipropylene glycol, 2,2-bis[4-(2-hydroxy ethoxy)-phenyl] propane, the hydroxy pivalic ester of neopentyl glycol, butylethylpropane diol and ethylmethylpropane diol.

Small amounts, for example less than about 20 wt % and preferably less than 15 wt %, of trifunctional alcohols may be used in order to obtain branched polyesters. Examples of suitable polyols include glycerol, hexanetriol, trimethylol ethane, trimethylol propane and tris-(2-hydroxyethyl)-isocyanurate. Examples of suitable polyfunctional alcohols and acids are sorbitol, pentaerythritol and pyromellitic acid.

The polyester may be prepared according to conventional procedures by esterification or transesterification, optionally in the presence of customary esterification catalysts for example dibutyltin oxide or tetrabutyl titanate. Preparation conditions and the COOH/OH ratio can be selected so as to obtain end products that have an acid number and/or a hydroxyl number within the targeted range of values.

Generally, the polymer has an acid value between 20 and 120 mg KOH/gram resin and more preferably between 20 and 80 mg KOH/gram resin.

The number average molecular weight (Mn) of the polymer may be for example between 2000 and 6000.

The polymer may have a viscosity at 158° C. that is lower than 150 Pa.s. The glass temperature, Tg, of the polymer may range between 20° C. and 80° C.

The quantity of the stabilisers may range between 0.1 and 3 wt % (relative to the binder composition) and is preferably between 0.5 and 2 wt %.

The weight ratio between the carboxylic acid compound and the hydroxyalkyl amide compound may range between 70:30 and 97:3, and is preferably between 80:20 and 95:5. The selection of this ratio may be governed by the envisaged application.

Examples of suitable compounds containing hydroxyalkyl amide units, which may be applied as the crosslinker, are compounds having a structure according to formula (III):

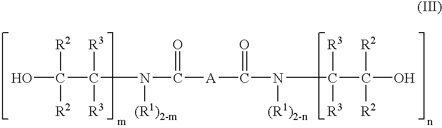

where:

A is a mono- or polyvalent organic group, derived from a saturated or non-saturated alkyl group having 1-60 carbon atoms (for instance ethyl, methyl, propyl, butyl, pentyl, hexyl, heptyl, octyl, nonyl, decyl, eicosyl, triacontyl, tetracontyl, pentacontyl, hexacontyl and the like); an aryl group, for example phenyl, naphthyl and the like; a trialkylene amino group, with 1-4 carbon atoms per alkylene group, for instance trimethylene amino, triethylene amino and the like; or an unsaturated residue with one or more alkenic groups (—C═C—) with (1-4) carbon atoms, for example ethenyl, 1-methylethenyl, 3-butenyl-1,3-diyl, 2-propenyl-1,2-diyl, a carboxyalkenyl group, for instance a 3-carboxy-2-propenyl group and the like, an alkoxycarbonylalkenyl group with (1-4) carbon atoms, for example a 3-methoxycarbonyl-2- propenyl group and the like;

R¹ is hydrogen, an alkyl group with 1-5 carbon atoms (for instance methyl, ethyl, n-propyl, n-butyl, sec.butyl, tert.butyl, pentyl and the like) or a hydroxyalkyl group with 1-5 carbon atoms (for instance 3-hydroxypropyl, 4-hydroxybutyl, 3-hydroxybutyl or de hydroxy derivatives of the pentyl isomers);

R² and R³ are identical or different and each represent hydrogen or a straight or branched alkyl group with 1-5 carbon atoms, while one of the groups R² and one of the groups R³ together with the adjacent carbon atoms can also form a cycloalkyl group, for example cyclopentyl and cyclohexyl; R² and R³ can also be hydroxyalkyl groups, for example hydroxy(C₁-C₅)alkyl groups, preference being given to hydroxymethyl and 1-hydroxyethyl, and

0≦n≦2

0≦m≦2.

Preferably, A=(C₁-C₁₀)alkyl or hydrogen, R¹=hydrogen and R² and R³=hydrogen or hydroxy(C₁-C₂)alkyl.

Preferred embodiments of the compound according to formula (III) are compounds according to formulas (IV) and (V):

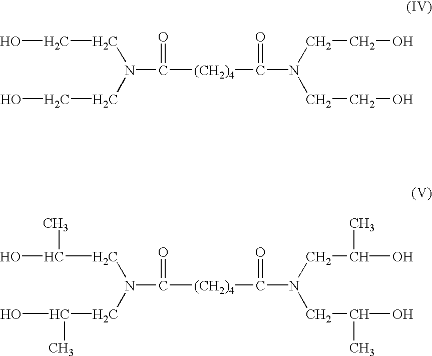

A suitable compound according to formula (IV) is commercially available as Primid™ XL552 (EMS) and a suitable compound according to formula (V) is commercially available as Primid™ QM1260 (EMS).

It is also possible to use as the compound containing hydroxyalkyl amide groups a condensation polymer as disclosed in for example WO-A-99/16810. This polymer may contain hydroxyalkyl amide groups having a weight average molecular mass of between 800 and 50000 g/mol, a number average molecular mass(Mₙ) of between 600 and 10000 and a hydroxyalkylamide functionality of between 2 and 250, inclusive.

This polymer may contain at least a group according to formula (VI):

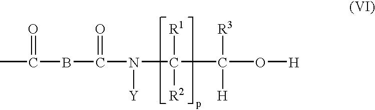

where

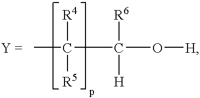

H, (C₁-C₂₀) (cyclo) alkyl or (C₆-C₁₀) aryl,

B=(C₂-C₂₀), optionally substituted, aryl or (cyclo)alkyl aliphatic diradical, R¹, R², R³, R⁴, R⁵ and R⁶ are identical or different, and independently of each other can be H, (C₆-C₁₀) aryl- or (C₁-C₈)(cyclo)alkyl radicals and p=1-4.

Preferably p=1.

The polymer containing P-hydroxyalkyl amide groups, which may be applied as the crosslinker, may be a polymer according to formula (VII):

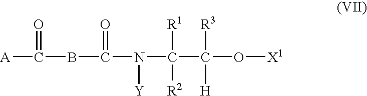

where:

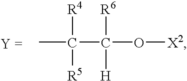

H, (C₁-C₂₀) (cyclo) alkyl or (C₆-C₁₀)aryl

B=(C₂-C₂₀), optionally substituted, aryl or (cyclo)alkyl aliphatic diradical,

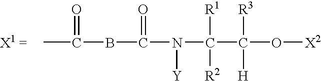

X²=H or X¹ and

R¹, R², R³, R⁴, R⁵ and R⁶ are identical or different, and independently of each other can be H, (C₆-C₁₀) aryl or (C₁-C₈) (cyclo)alkyl radicals or CH₂-OX².

In all formulas, R groups together or with adjacent carbon atoms can form part of a cycloalkyl group or an aryl group.

In a preferred embodiment the polymer containing β-hydroxyalkyl amide groups is a polymer according to formula (VIII):

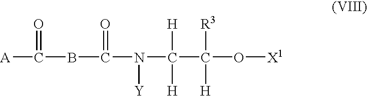

where:

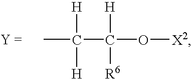

H, (C₁-C₂₀) (cyclo) alkyl or (C₈-C₁₀) aryl,

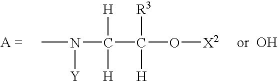

B=(C₂-C₂₀), optionally substituted, an aryl or (cyclo)alkyl aliphatic diradical,

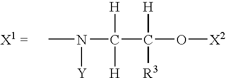

X²=H or X¹,

R³=H or (C₆-C₁₀) aryl or (C₁-C₈)alkyl radical and

R⁶=H or (C₆-C₁₀) aryl or (C₁-C₈)alkyl radical.

Copolymers that are hydroxylamide functional as well as carboxyl or anhydride functional can also be used, as can self-curing polymers.

Monomers, oligomers and polymers are suitable for use as compounds containing carboxylic acid groups.

Examples of suitable monomers are (C₁-C₂₆) alkyl carboxylates, (C₆-C₂₀) aryl carboxylates and unsaturated carboxylic acids, for example methacrylic acid, acrylic acid, crotonic acid, semi-esters of itaconic acid, maleic acid and fumaric acid.

Examples of suitable polymers include polyesters, polystyrenes, polyacrylates and polyurethanes containing carboxyl groups. By preference, polyesters are used.

It is also possible to apply a condensation polymer having at least one carboxylic acid endgroup connected to an alkylamide group via an ester linkage as the compound comprising hydroxylalkyl amide units.

This polymer may contain at least two groups according to formula (IX)

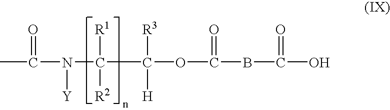

in which

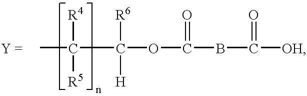

H, (C₁-C₂₀) (cyclo) alkyl, or (C₆-C₁₀) aryl, B=(C₂-C₂₄), optionally substituted, aryl or (cyclo)alkyl aliphatic diradical,

R¹, R², R³, R⁴, R⁵ and R⁶ may, independently of one another, be the same or different, H, (C₆-C₁₀) aryl or (C₁-C₈)(cyclo)alkyl radical and n=1-4.

It is also possible to use a compound comprising hydroxyl amide groups obtained by a process in which at first a compound comprising hydroxyalkyl amide units and carboxylic acid units is obtained by reacting a cyclic anhydride and an alkanolamine in a mixing device and that secondly the binder composition is obtained by mixing said compound and a polymer in a second mixing device. The compound comprising hydroxyalkyl amide units and carboxylic acid units preferably has a weight average molecular weight less than 800.

The preparation of thermosetting powder coatings in general and the chemical curing reactions of powder paints to cured coatings are described by Misev in Powder Coatings, Chemistry and Technology (1991, John Wiley) on pp. 42-54, pp. 148 and 224-226.

If desired, the usual additives, for example pigments, fillers, degassing agents, flow-promoting agents and stabilizers can be incorporated into the binder composition and the powder paint composition.

The powder paint composition according to the invention can be used together with or without pigments.

In a preferred embodiment of the invention the powder paint composition is used non-pigmented (“clearcoat”).

If pigments are used those that have no interaction with the selected catalyst are preferred. If pigments are used both inorganic and organic pigments are suitable for example, titanium dioxide, zinc sulphide, iron oxide and chromium oxide, and as organic pigments, for example azo compounds.

Suitable fillers include for example metal oxides, silicates, carbonates and sulphates.

Suitable stabilizers include for example: hindered amine light stabilizers (HALS), lactones, hydroxylamines and UV-absorbers for example hydroxybenzophenones, hydroxybenzotriazoles, triazines for example 2-[4,6-diphenyl-1,3,5-trazin-2-yl]-5-(hexyl)oxy-phenol (Tinuvin™ 1577, Ciba Specialty Chemicals) or 2,4-bis (2,4-dimethylphenyl)-6-(2-hydroxy-4-n-octyloxyphenol)-1,3,5-triazine (Cyasorb™ UV1164, Cytec).

Examples of degassing agents are benzoin and cyclohexane dimethanol bisbenzoate. The range of flow-promoting agents includes for instance polyalkyl acrylates, fluorocarbons and silicon oils. Other suitable additives are for example additives for improvement of the triboelectric chargeability, for example sterically hindered tertiary amines which are described in EP-B-0.371.528.

Powder paints according to the invention may be applied in the customary manner, for example by electrostatic spraying of the powder onto an earthed substrate and by curing the paint by exposing it to heat at a suitable temperature and for a sufficiently long time. The applied powder can be heated, for example, in a gas oven or in an electric oven or by means of infrared irradiation.

Thermosetting coatings based on powder paint compositions for industrial applications are further described in a general sense in Powder Coatings, Chemistry and Technology, Misev, pp. 141-173 (1991).

Compositions according to the present invention may be applied for use on, for example, metal, wood and plastic substrates. Examples are industrial coatings, coatings for machines and tools, domestic applications and component parts of buildings. The coatings are further suitable for use in the automotive industry for coating of parts and accessories.

The composition according to the invention may also be used for example in other technical fields of the coating industry, in toner compositions, in printing ink applications and in the technical field of adhesives applications.

The invention will now be elucidated by means of the following non-restrictive examples.

### EXPERIMENT 1

### Preparation of a Compound Containing Hydroxyalkyl Amide Units

589 g diisopropanol amine was introduced into a double-walled glass reactor, heatable with heating oil, provided with a mechanical stirrer, a destination head and nitrogen supply and vacuum connections. While stirring, the diisopropanolamine was gradually heated to approx. 130° C. At this point 468 g of solid phthalic anhydride flakes was dosed into the reactor at such speed that the reactor temperature did not exceed 150° C. (reaction is highly exothermic). After addition of all the phthalic anhydride the reactor temperature was fixed on 150° C. After 2 hours vacuum was applied. The pressure in the reactor was adapted to the release of reaction water, so that this could be removed out of the reactor by destillation. After a total reaction time of 5 hours the viscous polymer contained less than 0.2 meq/g carboxylic acid (determined titrimetrically) and it was not possible any more to distill off water. The polymer was obtained after cooling. The hydroxyl group content was found titrimetrically to be 6.1 meq/g. The number average molecular mass was determined by means of GPC (universal calibration) to be 900 g/mol and the weight average molecular mass was 1500 g/mol.

### EXAMPLE I, II, III AND COMPARATIVE EXAMPLE A

### Powder Paint Composition

The powder paint compositions according to Table 1 were prepared by mixing and extrusion (PRISM extruder, 110° C). The polyester (Uralac™ P 5127 from DSM Coating Resins) comprises units of terephthalic acid, adipic acid, neopentyl glycol, ethylene glycol and trimellitic anhydride.

Composition I contains a combination of 4,4-di-cumyl-di-phenyl-amine (Naugard™ 445, Uniroyal Chemical) and bis-(2,6-di-tbutyl-4-methyl-phenyl)-pentaerythritol-di-phosphite (Mark™ PEP 36, Asahi Denka Kogyo) whereas composition A does not contain any antioxidant. The composition of Example II contains a combination of tris(2,4-di-t-butylphenyl)phosphite (Irgafos™ 168; Ciba-Geigy), 1,3,5-tris-(4-t-butyl-2,6-dimethyl-3-hydroxy-benzyl)iso-cyanurate (Cyanox™ 1790; Cytec) and phenylphosphinic acid.

The composition of Example III contains a combination of bis-(2,6-di-t-butyl-4-methyl-phenyl)-pentaerythritol-di-phosphite (Mark™ PEP36, Asahi Denka Kogyo) and phenylphosphinic acid.

Example I, II and Comparative Example A were cured in an electrical oven, whereas Example III was cured in a gasoven.

The compositions were in the usual manner ground, sieved and electrostatically sprayed (Corona) onto 2 aluminium test panels. The panels of Example I, II and Comparative Example A were cured during 10 minutes at 200° C. in an electrical heated circulation oven and tested on colour (b*, Dr. Lange). After this cure cycle one panel was exposed to an additional heating cycle of 60 minutes at 220° C. and the other panel to an additional heating cycle of 10 minutes at 240° C. After this extra cure cycle both panels were also tested on colour. The panel of Example III was cured during 10 minutes at 200° C. in a gasoven and tested on colour. After this cure cycle the panel was exposed to an additional heating cycle of 30 minutes at 180° C. The panel was again tested on colour. Further the compositions were tested in relation to other relevant properties. The test results are shown in Table 1.

These examples show that the use of a combination of an aromatic amine and a phosphite or the combination of a phosphite, a phenolic anti-oxidant and a phosphinic acid results in a coating with improved overbake properties in an electrical oven whereas the other properties remain good.

The examples also show that the use of a combination of a phosphite and a phosphinic acid results in a coating with improved overbake properties in a gasoven, whereas the other remain good.

TABLE 1

| | Comp. Ex. A | Ex. I | Ex. II | Ex. III |
|---|---|---|---|---|
| Uralac ™ P 5127 | 165.1 | 165.1 | 165.1 | 165.1 |
| Comp. According to Exp.1 | 34.9 | 34.9 | 34.9 | 34.9 |
| Naugard ™ 445 | | 2.7 | | |
| (Uniroyal Chemical) | | | | |
| Mark ™ PEP 36 | | 1.3 | | 2.0 |
| (Asahi Denka Kogyo) | | | | |
| Irgafos ™ 168 | | | 1.3 | |
| Cyanox ™ 1790 | | | 0.2 | |
| Phenyl phosphinic acid | | | 1.8 | 2.0 |
| Kronos ™ 2310 (Kronos) | 100.0 | 100.0 | 100.0 | 100.0 |
| Resiflow ™ PV5 | 3.0 | 3.0 | 3.0 | 3.0 |
| (Worlée) | | | | |
| Benzoin | 0.3 | 0.3 | 0.3 | 0.3 |
| Dr. Lange colour b*; | 2.0 | 0.9 | 0.3 | |
| 10’ 200° C.^{1), 8)} | | | | |
| Dr. Lange colour b*; | 7.7 | 2.3 | 2.3 | |
| 10’ 200° C. + | | | | |
| 60’ 220° C.^{1), 8)} | | | | |
| Dr. Lange colour b*; | 4.6 | 1.5 | 3.1 | |
| 10’ 200° C. + | | | | |
| 10’ 240° C.^{1), 8)} | | | | |
| Dr. Lange colour b*; | 7.9 | — | — | 4.2 |
| 10’ 200° C. + | | | | |
| 30’ 180° C.^{1), 9)} | | | | |
| Impact resistance²⁾ | >160 | >160 | >160 | >160 |
| Ericksen Slow Penetration³⁾ | >8 | >8 | >8 | >8 |
| (mm) | | | | |
| Cross-hatch adhesion⁴⁾ | Gt 0 | Gt 0 | GT 0 | Gt 0 |
| Gel time⁵⁾ (sec) | 93 sec | 93 sec | 90 | 89 |
| Flow behaviour⁶⁾ | good | good | good | good |
| Blister limit⁷⁾ (μm) | >120 | >120 | >120 | >120 |

¹⁾ASTM-D-2244
²⁾ASTM-D-2794
³⁾ISO 1520, DIN 53156
⁴⁾ISO 2409, DIN 5315
⁵⁾DIN 55990
⁶⁾The flow is determined visually
⁷⁾The blister limit is determined at a temperature of 200° C. during 10 minutes.
⁸⁾Curing in an electrical heated circulation oven
⁹⁾Curing in a gasoven

1. A powder paint composition containing a compound comprising carboxylic acid units and a compound comprising hydroxyalkyl amide units characterized in that the composition comprises:
i. one or more phosphites
ii. and either:
a) one or more aromatic amine(s) or
b) one or more phosphinic acid(s) according to formula I or II: 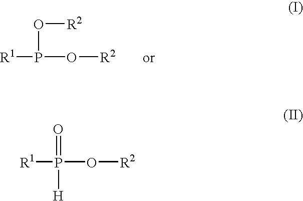
where
R¹=H, (C₁-C₂₆) alkyl or (C₆-C₂₀) aryl
R²=H, (C₁-C₂₆) alkyl or (C₆-C₂₀) aryl and
R³=H, (C₁-C₂₆) alkyl or (C₆-C₂₀) aryl,
iii. optionally combined with one or more phenolic anti-oxidants.

2. A composition according to claim 1, characterized in that the amine is 4,4-di-cumyl-di-phenyl-amine.

3. A composition according to any one of claims 1-2, characterised in that the compound comprising carboxylic acid units is a polyester.

4. A composition according to any one of claims 1-3 characterised in that the compound comprising hydroxyalkyl amide units is a condensation polymer having a number average molecular mass of between 600 and 10000 and a hydroxyalkylamide functionality of between 2 and 250, inclusive.

5. A composition according to any one of claims 1-3 characterised in that the compound comprising hydroxyalkyl amide units is a compound according to formula (IV) or (V):

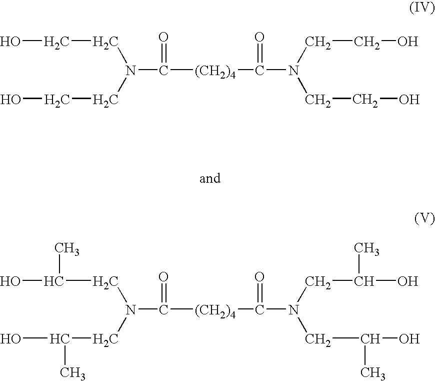

6. A composition according to any one of claims 1-3 characterised in that the compound comprising hydroxyalkyl amide units is a condensation polymer having at least one carboxylic acid endgroup connected to an alkylamide group via an ester linkage.

7. A composition according to any one of claims 1-3 characterised in that the compound comprising hydroxyalkyl amide units is a compound comprising hydroxyalkyl amide units and carboxylic acid units and having a weight average molecular weight less than 800 which is obtained by a process in which in a first step a compound comprising hydroxyalkyl amide units and carboxylic acid units is obtained by reacting a cyclic anhydride and an alkanolamine in a mixing device and that in a second step the binder composition is obtained by mixing said compound and a polymer in a second mixing device.

8. A composition according to any one of claims 1-7 characterized in that the phosphite tris-(2,4-di-tert-butyl-phenyl)-phosphite or bis-(2,6-di-tbutyl-4-methyl-phenyl)-pentaerythritol-di-phosphite is.

9. A composition according to any one of claims 1-8 characterized in that the phenolic anti-oxidant 1,3,5-tris-(4-tert-butyl-2,6-di-methyl-3-hydroxy-benzyl)-iso-cyanurate is.

10. A composition according to any one of claims 1-9 characterized in that the phosphinic acid, phenylphosphinic acid is.

11. A powder paint composition according to any one of claims 1-10 characterized in that at least one phenolic anti-oxidant is present.

12. A powder coating obtained by curing a powder paint composition according to any one of claims 1-11.

13. Wholly or partly coated substrate, characterized in that the coating applied is a powder coating according to claim 12.
